(19) United States
(12) Patent Application Publication
(10) Pub. No.: US 2016/0200839 A1
(43) Pub. Date: Jul. 14, 2016

(54) POLYPROPYLENE COMPOSITION COMPRISING A PROPYLENE COPOLYMER COMPONENT

(71) Applicant: BOREALIS TECHNOLOGY OY, Porvoo (FI)

(72) Inventors: Torvald VESTBERG, Porvoo (FI); Jaeaeskelaeinen PIRJO, Porvoo (FI); Bo MALM, Espoo (FI)

(73) Assignee: BOREALIS TECHNOLOGY OY

(21) Appl. No.: 15/079,796

(22) Filed: Mar. 24, 2016

Related U.S. Application Data
(63) Continuation of application No. 12/087,030, filed on Jun. 23, 2008, now abandoned.

(30) Foreign Application Priority Data
Dec. 22, 2005 (EP) 05028245.8

(51) Int. Cl. C08F 4/76; C08L 23/14

(52) U.S. Cl. CPC C08F 4/76; C08L 23/14; C08L 2201/10; C08L 2205/02

(57) ABSTRACT

The present invention concerns a polypropylene composition comprising a nucleated propylene copolymer having improved optical properties.

### REFERENCE TO RELATED APPLICATION

This is a continuation application of Ser. No. 12/087,030, filed Jun. 23, 2008, currently pending. The subject matter of the aforementioned prior application is hereby incorporated herein by reference.

### BACKGROUND OF THE INVENTION

The present invention concerns a polypropylene composition, comprising at least one propylene copolymer component, a method for preparing same, a catalyst suitable for the preparation of the polypropylene composition and the use of the polypropylene composition for the formation of wide variety of articles, such as, preferably, films and thermoformed, as well as molded articles, particularly moldings.

Polypropylene compositions are known in the art. Polypropylene compositions comprising a propylene copolymer component are, in particular, used for preparing moldings. Such applications require, on the one hand, a high degree of transparency of the polypropylene composition, while requiring on the other hand, also satisfactory mechanical properties. In the art, it is well known in this respect to improve the optical properties of a polypropylene composition by adding nucleating agents, also designated clarifiers. The European patent application EP 1 514 893 A1, for example, discloses polypropylene blown films comprising nucleating agents, selected for example from phosphoric acid ester metal salts as well as polymeric nucleating agents, for example vinyl cycloalkane polymers. Concerning propylene copolymers this application discloses copolymer components having MFR values of about 1.5. Similar nucleating agents are also disclosed in the international applications WO 99/24478 and WO 99/24479.

The international application WO 2004/055101 discloses a heterophasic propylene copolymer, containing nucleating agents, selected from phosphate-derived nucleating agents, sorbitol-derived nucleating agents, metal salts of aromatic or aliphatic carboxylic acids as nucleating agents, polymeric nucleating agents, such as polyvinyl cyclohexane and inorganic nucleating agents, such as talc.

U.S. Pat. No. 4,551,501 finally discloses a crystalline propylene polymer composition comprising a blend of a crystalline polypropylene with a polymer of a vinyl cycloalkane. This US patent discloses that the polymer of the vinyl cycloalkane is introduced into the polymer composition using master batch technology.

In WO 2005026240 is disclosed a polypropylene based blown film which contains a clarifier containing phosphate-based alpha-nucleating agent and/pr polymeric alpha-nucleating agents. However, no example of the use of polymeric nucleating is disclosed.

A drawback of the prior art compositions, however, is the fact that a sufficient transparency often cannot be obtained, in particular with polymeric nucleating agents. Approaches using the master batch technology often suffer from the drawback that it is very troublesome to incorporate by mechanical blending high amounts of nucleating agents with a satisfactory degree of evenness of the distribution into a polymer composition. On the other hand, low molecular weight nucleating agents, such as sorbitol-derived nucleating agents, are relatively costly which is unfavorable, since high amounts thereof are often needed. Furthermore, such low molecular weight components may give rise to further problems during the lifetime of a manufactured product, such as migration, blooming etc., resulting in a deterioration of the product quality, with respect to the optical properties such as haze and transparency as well as with respect to physical properties.

Accordingly, it is the object of the present invention to provide a further polypropylene composition overcoming the drawback associated with the prior art. In particular, the present invention aims at providing an advantageous polypropylene composition comprising at least one propylene copolymer component, wherein satisfactory optical properties, in particular haze values and transparency can be obtained in a simple and reliable manner. In this respect, the present invention also aims at providing a suitable process for preparing a polypropylene composition satisfying the requirements as outlined above and suitable catalysts therefor.

### SUMMARY OF THE INVENTION

The present invention solves the above-outlined object by providing a polypropylene composition. The present invention furthermore provides a polymerization catalyst. Furthermore, the present invention provides a process for producing a polypropylene composition and also the use.

### BRIEF DESCRIPTION OF THE DRAWINGS

FIG. 1 shows the relationship between haze and the amount of PVCH in the polymer composition, for propylene copolymers in accordance with the present invention and two comparative examples (see Table 1). FIG. 2 shows the relationship between haze and the weight ratio of VCH to catalyst for the examples as derivable from Table 1.

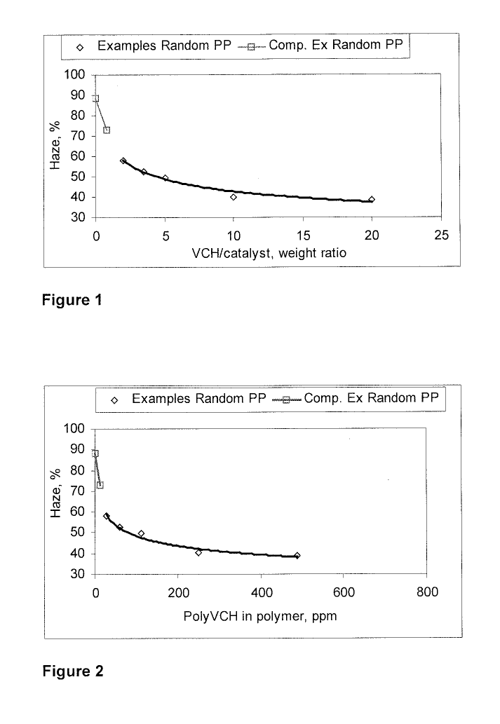

### DETAILED DESCRIPTION OF THE INVENTION

A polypropylene composition in accordance with the present invention is characterized by the common feature that a specific combination of MFR₂ and haze is provided, which may be expressed either by defining specific MFR₂ values of 15 g/10 min or less in combination with a haze value of below 55% when determined according to ASTMD 1003 with 2 mm thick injection molded plaque samples, or by defining a lower limit for the MFR₂ value of 0.5 g/10 min and a haze definition by means of an inequality including the parameters MFR₂, comonomer content and amount of polymeric nucleating agent. The following specification describes further embodiments which are independently valid for described polypropylene composition alternatives which describe novel and improved polypropylene compositions.

However, the present invention also contemplates and claims polypropylene compositions being defined by specific MFR₂ values of 15 g/10 min or less in combination with a haze value of below 55% when determined according to ASTMD 1003 with 2 mm thick injection molded plaque samples, and by defining a lower limit for the MFR₂ value of 0.5 g/10 min and a haze definition by means of an inequality including the parameters MFR₂, comonomer content and amount of polymeric nucleating agent. Accordingly the present invention is also directed to a polypropylene composition. The following description thus concerns preferred embodiments for the subject-matter the described alternative compositions, individually, as well as for the combination of subject-matters of the alternative compositions.

Further, for the present invention a polypropylene composition, comprising
A) at least one propylene copolymer component, and
B) a polymeric nucleating agent,
wherein the mixture of A) and B) has a MFR₂ of 15 g/10 min or less as measured according to ISO 1133 (230° C., 2.16 kg load) and a haze, measured according to ASTMD 1003 in the form of an injection molded test piece having a thickness of 2 mm of below 55%, is a preferred embodiment of the polypropylene composition.

Finally, for the present invention a polypropylene composition, comprising
A) at least one propylene copolymer component, and
B) a polymeric nucleating agent,
wherein the mixture of A) and B) has a MFR₂ of 0.5 g/10 min or more as measured according to ISO 1133 (230° C., 2.16 kg load) and a haze, measured according to ASTMD 1003 in the form of an injection molded test piece having a thickness of 2 mm which satisfies the following relation:

Haze (%)<100.9·N^{(-0.1)}+3.88·MFR₂^{0.6}−19.1·Z^{0.5}−0.0232·MFR₂+2.41·Z+0.2

with N=amount of polymeric nucleating agent in the propylene copolymer in ppm (weight)
MFR₂=MFR₂ of the mixture of A) and B) (ISO 1133, 230° C., 2.16 kg load)
   Z=comonomer content in the propylene copolymer component in wt-%, is a preferred embodiment of the polypropylene composition.

The modality with respect to molecular weight distribution and thus with respect to melt flow ratio is not critical. Thus the polypropylene composition in accordance with the present invention may be unimodal or multimodal including bimodal with respect to molecular weight distribution. The polypropylene composition of the invention may also be multimodal with respect to comonomer distribution.

Accordingly, the polypropylene composition in accordance with the present invention comprises at least one propylene copolymer component. Preferably, the at least one propylene copolymer component is a random copolymer component, comprising propylene and at least one comonomer selected from ethylene, and C4 and higher α-olefins such as C4-C12, preferably C4 to C10, or preferably C4 to C8 α-olefins, which may be linear, branched, aliphatic, cyclic, saturated, partially unsaturated or aromatic. Preferred as comonomer is ethylene.

By the term “random copolymer” is meant herein that the comonomer in said copolymer is distributed randomly, i.e. by statistical insertion of the comonomer units, within the copolymer chain. Said term “random” copolymer is generally known and used in the art and abbreviated herein below as “polypropylene copolymer”.

In one embodiment the propylene copolymer component is unimodal with respect to MWD and with respect to the comonomer content. The polypropylene composition in accordance with the present invention may, however, also comprise more than one propylene copolymer component, preferably two components giving a bimodal composition, with respect to MWD and/or comonomer content.

Concerning suitable ranges of comonomer content, the present invention contemplates the use of comonomer contents in usual amounts, for example up to 20 wt %. Suitable lower limits are 0.5 and 1 wt %, so that suitable ranges for comonomer content are in particular 2 to 15 wt %, 2.5 to 10 wt %, and in particular 3 to 7 wt %.

As identified above and as further explained below, the propylene copolymer component may also be bimodal or multimodal with respect to the comonomer content, meaning that different propylene copolymer components may be mixed with each other, differing with respect to the type of comonomer contained and/or with respect to the amount of comonomer contained. The skilled person is readily aware of how such bimodal or multimodal propylene copolymer components can be obtained, for example by mechanical blending including mixing and melt blending processes and any combinations thereof as well as in-situ blending during the polymerization process of the propylene polymer component(s) as outlined further below.

The mixture of A) and B) as defined in claim 1 has a MFR₂ of from 0.5 g/10 min or more (determined as defined below), preferably the MFR₂ is 2 g/10 min or more, and in some embodiments from 1 to 20 g/10 min or from 1 to 10 g/10 min.

When the polypropylene composition in accordance with the present invention is at least bimodal with respect to the molecular weight distribution concerning the propylene copolymer components, such an embodiment may be realized by including two different propylene copolymer components, differing at least with respect to the MFR₂ and/or the comonomer content.

Such a bimodal embodiment may be exemplified by a mixture of a lower molecular weight component with a higher molecular weight component. The lower molecular weight (LMW) component has a higher MFR₂ than the higher molecular weight (HMW) component. The amount of the LMW component is typically between 30 to 70 wt %, preferably 40 to 60 wt % of the total amount of propylene copolymer. The amount of the HMW component is typically between 30 to 70 wt %, preferably 40 to 60 wt % of the total amount of propylene copolymer.

In another bimodal embodiments, the ratio between the MFR₂ of LMW component and MFR₂ of HMW component is typically from 1 up to 400, preferably at least 20, preferably at least 30, more preferably at least 40. The upper limit of said ratio may be preferably up to 200. Other embodiments with lower ratios are, however, also envisaged by the present invention.

The polypropylene composition in accordance with the present invention may also comprise additional propylene components, including propylene homopolymers, and in particular also further propylene homopolymers and/or propylene copolymers with ethylene yielding heterophasic propylene compositions, comprising a matrix phase and a dispersed phase.

The at least one propylene copolymer component preferably has a shear thinning index SHI_{0/50} of less than 10, preferably less than 8. A suitable range is in particular from 2 to 8.

In accordance with the present invention, it is furthermore preferred that the polypropylene composition has a tensile modulus of below 1700 MPa, the lower limit typically being 500 MPa, such as 600 to 1500 MPa.

In one embodiment of a unimodal polypropylene composition the polydispersity index (PI) is less than 5, preferably less than 3.5, preferably from 2 to 4.

XS is not critical and depends on the ethylene content desired for the end polymer.

Furthermore, it is preferred for the unimodal polypropylene composition in accordance with the present invention to have a molecular weight distribution, MWD, as calculated from M_{w}/Mₙ values obtained from the size exclusion chromatography (SEC, also known as GPC) of preferably less than 10, in particular less than 5, the lower limit being 2.

The polypropylene composition in accordance with the present invention is furthermore characterized in that it comprises a polymeric nucleating agent. Any known polymeric nucleating agent may be employed, preferably vinyl cylcoalkane and/or vinyl alkane. A preferred example of such a polymeric nucleating agent is a vinyl polymer, such as a vinyl polymer derived from monomers of the formula

CH₂═CH—CHR₁R₂

wherein R₁ and R₂, together with the carbon atom they are attached to, form an optionally substituted saturated or unsaturated or aromatic ring or a fused ring system, wherein the ring or fused ring moiety contains four to 20 carbon atoms, preferably 5 to 12 membered saturated or unsaturated or aromatic ring or a fused ring system or independently represent a linear or branched C4-C30 alkane, C4-C20 cycloalkane or C4-C20 aromatic ring. Preferably, R₁ and R₂, together with the C-atom they are attached to, form a five- or six-membered saturated or unsaturated or aromatic ring or independently represent a lower alkyl group comprising from 1 to 4 carbon atoms. Preferred vinyl compounds for the preparation of a polymeric nucleating agent to be used in accordance with the present invention are in particular vinyl cycloalkanes, in particular vinyl cyclohexane (VCH), vinyl cyclopentane, and vinyl-2-methyl cyclohexane, 3-methyl-1-butene, 3-ethyl-1-hexene, 3-methyl-1-pentene, 4-methyl-1-pentene or mixtures thereof. VCH is a particularly preferred monomer.

The polymeric nucleating agent usually is present in the final product in an amount of from more than 15 ppm, such as more than 20 ppm, (based on the weight of the polypropylene composition). Preferably this agent is present in the polypropylene composition in a range of from 20 to 800 ppm, more preferably in an amount of more than 50 ppm, such as 100 to 600 ppm.

The polymeric nucleating agent usually is present in an amount of from 15 to 1000 ppm, and preferably this agent is present in the polypropylene composition.

The use of the polymer nucleating agent in accordance with the present invention enables the preparation of polypropylene compositions having very satisfactory optical properties and satisfactory mechanical properties, so that it is not required for the compositions in accordance with the present invention to contain low molecular weight nucleating agents, in particular costly sorbitol-derived nucleating agents. Accordingly, the present invention provides an alternative means for improving the transparency of propylene copolymer compositions, especially in end applications wherein the use of low molecular weight nucleating agents as clarifiers is not desirable, such as in many medical and food applications with strict purity requirements and regulations.

Moreover, the present invention achieves highly advantageous haze values of the polypropylene composition as defined herein using relatively low amounts of polymeric nucleating agents. The low molecular weight nucleating agents require usually higher amounts to obtain comparable results in transparency.

The polypropylene composition in accordance with one embodiment of the present invention comprising the essential components as defined above, i.e. the at least one propylene copolymer component A) and the polymeric nucleating agent B), enables the preparation of polypropylene compositions giving rise to compositions having a haze, measured in the form of an injection molded test piece having a thickness of 2 mm (test method identified below) satisfying the following relation:

Haze (%)<100.9·N^{(-0.1)}+3.88·MFR₂^{0.6}−19.1·Z^{0.5}−0.0232·MFR₂+2.41·Z+0.2

with N=amount of polymeric nucleating agent in the propylene copolymer component in ppm (weight)
MFR₂=MFR of the mixture of A) and B)
Z=comonomer content in the propylene copolymer component in wt-%

As outlined in the present application the comonomer preferably is ethylene. It is also preferred when the polymeric nucleating agent is PVCH, as disclosed herein. The preferred ranges for N, MFR₂ and Z are, independently as follows:

N: from 15 to 1000 ppm
MFR₂: from 1 to 50 g/10 min
Z: from 0.5 to 7 wt %.

For each of the ranges illustrated above the further preferred embodiments as derivable from the present application likewise apply.

The polypropylene composition in accordance with the present invention may be prepared by any suitable process, including in particular blending processes such as mechanical blending including mixing and melt blending processes and any combinations thereof as well as in-situ blending during the polymerization process of the propylene polymer component(s). Such blending processes can be carried out by methods known to the skilled person, including batch processes and continuous processes.

It is also possible to prepare the polypropylene composition in accordance with the present invention by sequential polymerization processes, wherein the single components of the polypropylene composition are prepared, one after the other, in the presence of the already prepared components. Such a process for preparing the polypropylene composition is preferred and yields a reactor blend or reactor made polymer composition, which means herein the reaction product obtained from a polymerization reaction wherein, for example, the propylene copolymer component is polymerized in the presence of the polymeric nucleating agent.

The reactor made polymer composition (in-situ blend) defines a different embodiment compared to a mechanical blend of a polymer with a nucleating agent, wherein the polymer is first produced in the absence of a polymeric nucleating agent and is then blended mechanically with the polymeric nucleating agent or with a small amount of nucleated polymer (so-called master batch technology) in order to introduce the polymeric nucleating agent into the polymer mixture. The preparation of a reactor made polymer composition ensures the preparation of a homogenous mixture of the components, for example a homogenously distributed polymeric nucleating agent in the polypropylene composition, even at high concentrations of polymer nucleating agent. As outlined above, the reactor made polymer composition is a preferred embodiment of the present invention, although also mechanical blends prepared, for example, by using master batch technology are envisaged by the present invention.

Similar considerations also apply with respect to the preparation of multimodal including bimodal polypropylene compositions, in particular the compositions comprising two different propylene copolymer components with differing MFR₂ values and/or comonomer contents. While such multimodal or bimodal components may also be prepared by mechanical blending processes, it is preferred in accordance with the present invention to provide such multimodal or bimodal compositions in the form of a reactor made compositions, meaning that the second (or any further) component is prepared in the presence of the first component (or any preceding components).

A suitable process for preparing reactor made compositions is outlined below.

The propylene copolymer component to be employed in accordance with the present invention in principle can be prepared by any polymerization method, including solution, slurry and gas phase polymerization. Slurry polymerization preferably designates a bulk polymerization. Bulk polymerization defines a polymerization in a reaction medium comprising at least 60 wt % monomer.

In case of the unimodal polypropylene copolymer the copolymer is unimodal with respect to MWD and comonomer content, whereby the copolymer can be polymerized in a single stage batch or preferably continuous process. The polymerization can be a slurry or gas phase, preferably a slurry, such as loop, polymerization. Alternatively, the unimodal polymer may be produced in a multistage process using at each stage process conditions which result in similar polymer properties.

In accordance with another embodiment of the present invention, the polypropylene composition comprises two different propylene copolymer components, preferably differing in particular with respect to MFR₂ and/or comonomer content. Such a mixture of two propylene copolymer components preferably may be produced in accordance with the present invention in a multistage process using one or more polymerization reactors, which may be the same or different, for example, at least slurry-slurry, gas phase-gas phase or any combination of slurry and gas phase polymerization. Each stage may be effected in parallel or sequentially using same or different polymerization methods. Advantageously, the above-mentioned mixture of the two different propylene copolymer components is prepared in a sequence comprising at least one slurry polymerization and at least one gas phase polymerization. Suitably, the slurry polymerization is the first polymerization step, followed by a gas phase polymerization. This order, however, may also be reversed. In the case of such a sequential polymerization reaction, each component may be produced in any order by carrying out the polymerization in each step, except the first step, in the presence of the polymer component formed in the preceding step. Preferably, the catalyst used in the preceding step is also present in the subsequent polymerization step. Alternatively, it is also possible to add additional quantities of the identical catalyst or of a different catalyst in a subsequent polymerization step.

A suitable possibility of forming a multimodal propylene copolymer component is a polymerization sequence comprising a first homo or copolymerization step in a slurry reactor, preferably a loop reactor, followed by a copolymerization step in a gas phase reactor, wherein the second propylene copolymer component is prepared in the presence of the already prepared first propylene copolymer component (prepared in the slurry reactor).

A preferred multistage process is the above-identified slurry-gas phase process, such as developed by Borealis and known as the Borstar® technology. In this respect, reference is made to the European applications EP 0 887 379 A1 and EP 517 868 A1, both incorporated herein by reference.

The above-outlined description of preferred and suitable multistage polymerization processes have been exemplified in connection with the preparation of compositions comprising different propylene copolymer components. These processes may, however, also be advantageously employed in order to prepare the above-outlined compositions in accordance with the present invention which not only comprise at least one propylene copolymer component but also propylene homopolymer component. With respect to the above-outlined preferred processes for preparing compositions in accordance with the present invention, it is, for example, envisaged to prepare first the propylene homo polymer component in the first stage of the reaction, for example in a slurry reaction (loop reactor) while preparing a propylene copolymer component then in an a subsequent gas phase reaction (for example, fluidized bed reactor) in order to prepare a reactor blend in accordance with the present invention. According to this embodiment, it is also preferred to use a modified catalyst as discussed below in order to incorporate the polymeric nucleating agent already into the polypropylene composition in accordance with the present invention during the preparation thereof. The above-outlined sequence of reaction steps of preparing the copolymer component and the homopolymer component may, however, also be reversed in order, i.e. it is also contemplated to first prepare a propylene homopolymer component in a slurry reaction, followed by feeding the reaction product to a subsequent reaction, suitably a gas phase reaction in order to prepare the at least one propylene copolymer component in accordance with the present invention.

Using these approaches, it is possible to prepare reactor blends in accordance with the present invention, i.e. comprising the polymeric nucleating agent and the at least one propylene copolymer component, in intimate admixture with a further component, such as the propylene homopolymer component identified above.

Naturally, the multimodal copolymer composition of the invention may also have two or more copolymer components which differ with respect to the type of comonomer(s) used to prepare the two or more propylene copolymer components.

In the case of multimodal compositions, at least with respect to the molecular weight distribution or MFR₂, the composition comprises a low molecular weight component (LMW) and a higher molecular weight component (HMW). The LMW component and the HMW component are made in different steps in any order. Preferably, typically when a Ziegler-Natta catalyst is used, the HMW fraction is produced in the first step and the LMW fraction is produced in the subsequent step, in the presence of the HMW fraction.

One example of a suitable sequential polymerization method for preparing multimodal, including bimodal compositions as exemplified above, is a process employing first a slurry reactor, for example a loop reactor, followed by a second polymerization in a gas phase reactor. Such a reaction sequence provides a reactor blend of different propylene copolymers for which the MFR₂ values can be adjusted as, in principle, known to the skilled person during the sequential polymerization steps. It is of course possible and also envisaged by the present invention to carry out the first reaction in a gas phase reactor while the second polymerization is carried out in a slurry reactor, for example a loop reactor. The process as discussed above, comprising at least two polymerization steps, is advantageous in view of the fact that it provides easily controllable reaction steps enabling the preparation of a desired reactor blend of propylene copolymers. The polymerization steps may be adjusted, for example, by appropriately selecting monomer feed, comonomer feed, hydrogen feed, temperature, pressure, type and amount of catalyst, in order to suitably adjust the properties of the polymerization products obtained.

Optionally, the unimodal or multimodal processes described above can further comprise a prepolymerization step preceding the polymerization of above mentioned propylene polymer component(s) in a manner known in the field.

Such a process can be carried out using any suitable catalyst for the preparation of propylene polymers, including single site catalyst, including metallocenes and non-metallocenes, and Ziegler-Natta. Preferably, the process as discussed above is carried out using a Ziegler-Natta catalyst, in particular a high yield Ziegler-Natta catalyst (so called fourth and fifth generation type to differentiate from low yield, so called second generation Ziegler-Natta catalysts). A suitable Ziegler-Natta catalyst to be employed in accordance with the present invention comprises a catalyst component, a co-catalyst component and at least one electron donor (internal and/or external electron donor, preferably at least one external donor). Preferably, the catalyst component is a Ti—Mg-based catalyst component and typically the co-catalyst is an Al-alkyl biased compound. Suitable catalysts are in particular disclosed in U.S. Pat. No. 5,234,879, WO 92/19653, WO 92/19658 and WO 99/33843, all incorporated herein by reference.

Preferred external donors are the known silane-based donors, preferably dicyclopentyl dimethoxy silane or cyclohexyl methyldimethoxy silane.

An alternative to such multistage, multi-reactor processes is the preparation of a multimodal polymer component in one reactor as known to the skilled person. In order to produce a multimodal polymer composition, the skilled person in particular can control the reaction by changing polymerization conditions, using different types of catalyst and using different comonomer and/or hydrogen feeds.

With respect to the above-mentioned preferred slurry-gas phase process, the following general information can be provided with respect to the process conditions.

Temperature of from 40° C. to 110° C., preferably between 60° C. and 100° C., in particular between 70° C. and 90° C., with a pressure in the range of from 20 to 80 bar, preferably 30 to 60 bar, with the option of adding hydrogen in order to control the molecular weight. The reaction product of the slurry polymerization, which preferably is carried out in a loop reactor, is then transferred to the subsequent gas phase reactor, wherein the temperature preferably is within the range of from 50° C. to 130° C., more preferably 60° C. to 100° C., at a pressure in the range of from 5 to 50 bar, preferably 15 to 35 bar, again with the option of adding hydrogen in order to control the molecular weight.

The residence time can vary in the reactor zones identified above. In embodiments, the residence time in the slurry reaction, for example the loop reactor, is in the range of from 0.5 to 5 hours, for example 0.5 to 2 hours, while the residence time in the gas phase reactor generally will be from 1 to 8 hours.

In a further preferred embodiment of the present invention, the polymeric nucleating agent is introduced into the polypropylene composition by means of a suitably modified catalyst, i.e. the catalyst to be used in catalyzing the polymerization of the propylene copolymer is subjected to a polymerization of a suitable monomer for the polymeric nucleating agent to produce first said polymeric nucleating agent. The catalyst is then introduced together with the obtained polymeric nucleating agent to the actual polymerization step of the propylene copolymer component(s).

In a particularly preferred embodiment of the present invention, the propylene copolymer is prepared in the presence of such a modified catalyst to obtain said reactor made polypropylene composition. With such modified catalyst, it is also possible to carry out the above-identified polymerization sequence for the preparation of in-situ blended multimodal, including bimodal propylene random copolymers.

A preferred polypropylene composition in accordance with the present invention accordingly is obtainable by preparing a propylene copolymer in the presence of a modified catalyst, wherein the modified catalyst is obtainable by polymerizing a vinyl compound having the formula

CH₂═CH—CHR₁R₂

wherein R₁ and R₂ are as defined previously herein, at a weight ratio of the vinyl compound to polymerization catalyst of two or more, in the presence of said catalyst, until the concentration of unreacted vinyl compound is less than about 0.5 wt %, preferably less than 0.1 wt %.

Concerning the modification of catalyst reference is made to the international applications WO 99/24478, WO 99/24479 and particularly WO 00/68315, all incorporated herein by reference with respect to the reaction conditions concerning the modification of the catalyst as well as with respect to the polymerization reaction.

In this respect, the present invention furthermore provides a catalyst, suitable for the preparation of polypropylene compositions, wherein the polymerization catalyst is obtainable by polymerizing a vinyl compound of the formula

CH₂═CH—CHR₁R₂

wherein R₁ and R₂ are as defined herein, at a weight ratio of the vinyl compound to polymerization catalyst amounting to 2 or more, in the presence of said catalyst, until the concentration of unreacted vinyl compound is less than about 0.5 wt %, preferably less than 0.1 wt %.

The preferred embodiments as described previously in the present application with respect to the vinyl compound also apply with respect to the polymerization catalyst of the present invention and the preferred polypropylene composition in accordance with the present invention.

The weight ratio of vinyl compound to polymerization catalyst in the modification step of the polymerization catalyst preferably is 3 or more, in particular 3.5 to 50, preferably 4.0 to 40, such as 5.0 to 15.

General conditions for the modification of the catalyst, suitable catalyst, co-catalyst, donors, liquid media and process parameters are also disclosed in WO 00/68315, incorporated herein by reference with respect to the modification of the polymerization catalyst. In the present invention preferably, increased ratio of VCH:catalyst is used. Suitable media for the modification step include, in addition to oils, also aliphatic inert organic solvents with low viscosity, such as pentane and heptane. Furthermore, small amounts of hydrogen can be used during the modification.

Suitable catalyst components for the catalyst of the present invention are all types of catalysts known for the preparation of propylene polymers, including single site catalyst, including metallocenes and non-metallocenes, and Ziegler-Natta. Preferred herein are Ziegler-Natta catalysts, in particular a high yield Ziegler-Natta catalyst (so called fourth and fifth generation type to differentiate from low yield, so called second generation Ziegler-Natta catalysts). A suitable Ziegler-Natta catalyst to be employed in accordance with the present invention comprises a catalyst component, a co-catalyst component and at least one electron donor (internal and/or external electron donor, preferably at least one external donor). Preferably, the catalyst component is a Ti—Mg-based catalyst component and typically the co-catalyst is an Al-alkyl based compound. Suitable catalysts are in particular disclosed in U.S. Pat. No. 5,234,879, WO 92/19653, WO 92/19658 and WO 99/33843, all incorporated herein by reference. Further suitable examples are the catalysts as employed in the examples shown in the present application, comprising a Ti based metal component, an Al based co-catalyst and a silane based donor.

Preferred external donors are the known silane-based donors, preferably dicyclopentyl dimethoxy silane or cyclohexyl methyldimethoxy silane.

As already discussed above, the present invention provides an improved polypropylene composition including at least one propylene copolymer component and a polymeric nucleating agent, with improved optical properties, in particular improved haze values. In embodiments, the present invention provides polypropylene compositions as defined above having a haze, measured in the form of an injection molded test piece having a thickness of 2 mm, of below 60%, in embodiments 50% and even below 40%.

With decreasing MFR₂, the transparency can typically further be increased. Thus in another embodiment, preferable for molded articles, the polypropylene composition has MFR₂ of ≦15 g/10 min, e.g. 7-15 g/10 min and haze of below 55%, preferably below 50%. In some embodiments even lower such as 40% may be desired.

Further unexpectedly, the amount of the polymeric nucleating agent can be varied for adjusting the transparency of the polypropylene composition of the invention without any marked changes in the stiffness properties of the polymer.

In preferable embodiments of the present invention, wherein the propylene copolymer component is prepared using a modified catalyst which already comprises the polymeric nucleating agent, whereby very even distributions of the polymeric nucleating agent can be achieved in the polypropylene composition, so that, relatively, small amounts of nucleating agent are sufficient in order to achieve the desired haze values.

The polypropylene composition in accordance with the present invention may be used for the manufacture of molded and extruded articles, for example articles produced by injection molding, compression molding, thermoforming, blow molding or foaming. The polypropylene composition in accordance with the present invention is suitable for preparing for the manufacture of i.a. sheets, films cups, pails, bottles, containers, boxes, automotive parts, appliances, technical articles, caps, closures and lids, as well as pipes, tubes, cables etc. In particular, the polypropylene compositions in accordance with the present invention are suitable for molding applications.

The polypropylene composition in accordance with the present invention may also comprise additional polymer component(s), e.g. propylene component(s), including propylene copolymers, in particular copolymers with ethylene and also heterophasic propylene compositions, wherein the above defined propylene copolymer is comprised in a so called matrix phase wherein an elastomeric copolymer of propylene and a comonomer, preferably at least ethylene is dispersed as a dispersed (rubber) phase.

Preferably, no disperse phase of elastomeric ethylene copolymer is present in the polypropylene composition.

The polypropylene composition in accordance with the present invention may be provided in the form of powder, fluff, spheres and pellets. In particular, when the polypropylene composition in accordance with the present invention is provided in the form of a reactor made composition the product is usually present in the form of powder, fluff or spheres. These compositions may be blended, compounded and pelletized further prior to the end application using conventional additional components, such as additives, fillers and reinforcing agents. Suitable additives include antioxidants, acid scavengers, antistatic agents, flame retardants, light and heat stabilizers, lubricants, nucleating agents, clarifying agents, pigments and other coloring agents, including carbon black. Fillers such as talc, mica and wollastonite can also be used.

Furthermore the properties of the polypropylene composition of the present invention may be modified further, for example by subjecting a reactor made composition to further processing steps, prior or following the compounding as exemplified above, such as post reactor chemical modification of the MFR₂ of the polymer (visbreaking) using for example peroxides for increasing MFR₂.

### DEFINITIONS AND DETERMINATION METHODS USED IN CLAIMS, THE ABOVE DESCRIPTION AND IN THE EXAMPLES

The xylene solubles (XS, wt %): analysis according to the known method: 2.0 g of polymer was dissolved in 250 ml p-xylene at 135° C. under agitation. After 30±2 minutes the solution was allowed to cool for 15 minutes at ambient temperature and then allowed to settle for 30 minutes at 25±0.5° C. The solution was filtered and evaporated in nitrogen flow and the residue dried under vacuum at 90° C. until constant weight is reached.

XS %=(100×m₁×v₀)/(m₀×v₁), wherein

m₀=initial polymer amount (g)
m₁=weight of residue (g)
v₀=initial volume (ml)
V₁=volume of analyzed sample (ml)

MFR₂ is measured in accordance with ISO 1133 (230° C., 2.16 kg load).

Mw, Mn, MWD: The determination of weight average molecular weight (Mw) and number average molecular weight (Mn) and the molecular weight distribution (MWD=Mw/Mn) by size exclusion chromatography (SEC): Mw, Mn and MWD (Mw/Mn) were determined with A Millipore Waters ALC/GPC operating at 135° C. and equipped with two mixed bed and one 10⁷ Å TSK-Gel columns (TOSOHAAS 16S) and a differential refractometer detector. The solvent 1,2,4-trichlorobezene was applied at flow rate of 1 ml/min. The columns were calibrated with narrow molecular weight distribution polystyrene standards and narrow and broad polypropylenes. Reference is also made to ISO 16014.

Comonomer content (weight percent) is determined in a known manner based on FTIR, calibrated with C13NMR.

Melting temperature, crystallization temperature and degree of crystallinity are measured with a Mettler TA820 differential scanning colorimetry device (DSC) on 3±0.5 mg samples. Crystallization and melting temperatures are obtained during 10° C./min cooling and heating scans between 30° C. and 225° C. Melting and crystallization temperatures were taken as the peaks of endotherms and exotherms. The degree of crystallinity is calculated by comparison with the heat or fusion of a perfectly crystalline polypropylene, i.e. 209 J/g.

Flexural modulus is measured according to ISO 178 (room temperature, if not otherwise mentioned), by using injection molded test specimens as described in EN ISO 1873-2 (80×10×4 mm). In case of bench scale tests of examples 1 to 5 and comparative example 1 and 2 the flexural modulus was measured according to above ISO 178 (room temperature), except samples were injection moulded to plates (60×60×2 mm) and test bars (60×10×2 mm) for measurement were cut out from the plates in flow direction.

Charpy notched impact is measured according to ISO 179 (room temperature, 23° C. if not otherwise mentioned) using injection molded test specimen as described in EN ISO 1873-2 (80×10×4 mm).

Tensile strength, including tensile stress at yield and strain at yield, is measured according to ISO 572-2 (cross head speed 50 mm/min). Tensile modulus is measured according to ISO 572-2 (cross head speed 1 mm/min).

Haze and transparency are determined from 2 mm injection molded plaque samples according to ASTMD 1003.

Rheology: Dynamic rheological measurements were carried out with Rheometrics RDA-II QC on compression molded samples under nitrogen atmosphere at 200° C. using 25 mm-diameter plate and plate geometry. The oscillatory shear experiments were done within the linear viscoelastic range of strain at frequencies from 0.01 to 500 rad/s. (ISO6721-1)

The values of storage modulus (G′), loss modulus (G″), complex modulus (G*) and complex viscosity (η*) were obtained as a function of frequency (ω).

The Zero shear viscosity (η₀) was calculated using complex fluidity defined as the reciprocal of complex viscosity. Its real and imaginary part are thus defined by

f′(ω)=η′(ω)/[η′(ω)²+η″(ω)²] and

f″(ω)=η″(ω)/[η′(ω)²+η″(ω)²]

From the following equations

η′=G″/ω and η″=G′/(ω)

f′(ω)=G″(ω)·ω/[G′(ω)²+G″(ω)²]

f″(ω)=G′(ω)·ω/[G′(ω)²+G″(ω)²]

The polydispercity index, PI, is calculated from cross-over point of G′(ω) and G″(ω).

There is a linear correlation between f′ and f″ with zero ordinate value of 1/η₀. (Heino et al.¹)

For polypropylene this is valid at low frequencies and five first points (5 points/decade) are used in calculation of η₀.

Elasticity indexes (G′) and shear thinning indexes (SHI), which are correlating with MWD and are independent of MW, were calculated according to Heino^{1, 2}) (below).

SHI is calculated by dividing the Zero Shear Viscosity by a complex viscosity value, obtained at a certain constant shear stress value, G*. The abbreviation, SHI (0/50), is the ratio between the zero shear viscosity and the viscosity at the shear stress of 50 000 Pa.
1) Rheological characterization of polyethylene fractions. Heino, E. L.; Lehtinen, A; Tanner, J.; Seppälä, J. Neste Oy, Porvoo, Finland. Theor. Appl. Rheol., Proc. Int. Congr. Rheol., 11^{th} (1992), 1 360-362
2) The influence of molecular structure on some rheological properties of polyethylene. Heino, Eeva-Leena. Borealis Polymers Oy, Porvoo, Finland. Annual Transactions of the Nordic Rheology Society, 1995

Unless otherwise stated below, the injection molded samples (test specimen) were prepared under the following conditions: Barrel and nozzle temperature 200° C. and mould surface temperature 38-40° C. when injection molding the samples.

The following examples illustrate the invention.

### EXAMPLES

### Example 1

All raw materials were essentially free from water and air and all material additions to the reactors and the different steps were done under inert conditions.

200 ml Ondina oil 68 was added to a 1 liter glass reactor and heated to 85° C. and kept there for two hours while purging with nitrogen. While keeping about 0.5 bar nitrogen pressure in the reactor the temperature was decreased to 15° C. and 4.1 g triethyl aluminium, 1.8 ml dicyclopentyl dimethoxy silane and 18.1 g highly active and stereospecific Ziegler Natta catalyst (ZN catalyst) was added. The ZN catalyst was made according to Finnish patent No. 88047, and had Ti content 2.1 w-%. 36.2 g vinyl cyclohexane (VCH) (corresponds to VCH/catalyst weight ratio 2.0) was added during 23 minutes. The temperature was increased to 65° C. and kept there for 20 hours. 38 ml heated (85° C.) and nitrogen purged White Protopet wax was added. Finally the reactor was cooled to about 30° C. and samples of the VCH modified catalyst were taken for polymerization tests and for determining unreacted VCH content with gas chromatography.

Polymerization of propylene with the VCH modified catalyst was done in a 5 liter reactor with stirrer. 0.114 ml TEA (=Al/Ti molar ratio 250), 0.019 ml donor dicyclopentyl dimethoxy silane (=AI/Do molar ratio 10) and 30 ml pentane were mixed and allowed to react for 5 minutes. Half of the mixture was added to the reactor and the other half was mixed with 81 mg of the catalyst/oil/wax mixture. After 10 minutes the catalyst/oil/wax/TEA/donor dicyclopentyl dimethoxy silane/pentane mixture was added to the reactor. 550 mmol hydrogen and 1400 gram propylene were added into the reactor and temperature was raised to 80° C. within 20 minutes while mixing. In total 39 g ethylene was fed continuously into the reactor during polymerization. The reaction was stopped after 1 hour at 80° C. by flashing out unreacted propylene.

The polymer powder was stabilized with 1500 ppm Irganox B215 and 500 ppm Calcium stearate and pelletized and injection moulded into plates. Haze was measured from the plates and flexural modulus was measured on pieces cut from the plagues and the other analyses were done on pellets. The final polymer contained 3.2 w-% ethylene and had haze 58%. The other results are seen in Table 1.

### Example 2

VCH modification in this example was done in the same way as in Example 1, but the VCH amount was increased to VCH/catalyst weight ratio 3.5. Al/Ti and Al/Do molar ratio was 8 and modification temperature was 85° C. Polymerization was done as in Example 1, except that the temperature was 75° C. and hydrogen amount 650 mmol. The final polymer contained 3.4 w-% ethylene and had haze 52.7%. The other results are seen in Table 1.

### Example 3

VCH modification in this example was done in the same way as in Example 1, but the VCH amount was increased to VCH/catalyst weight ratio 5.0. VCH modification was done with Al/Ti and Al/Do molar ratio was 6.15 mmol hydrogen and modification temperature was 65° C. Polymerization was done as in Example 1, except that the polymerization temperature was 75° C. and hydrogen amount 650 mmol. The final polymer contained 3.4 w-% ethylene and had haze 49.7%. The other results are seen in Table 1.

### Example 4

VCH modification in this example was done in the same way as in Example 1, but the VCH amount was increased to VCH/catalyst weight ratio 10.0. VCH modification was done in pentane with Al/Ti and Al/Do molar ratio was 6, 15 mmol hydrogen and modification temperature was 65° C. Polymerization was done as in Example 1, except that polymerization temperature was 75° C. and hydrogen amount 650 mmol. The final polymer contained 3.1 w-% ethylene and had haze 40.2%. The other results are seen in Table 1.

### Example 5

VCH modification in this example was done in the same way as in Example 1, but the VCH amount was increased to VCH/catalyst weight ratio 20.0. VCH modification was done in pentane with Al/Ti and Al/Do molar ratio was 6.5, 8 mmol hydrogen and modification temperature was 65° C. Polymerization was done as in Example 1 except that the polymerization temperature was 75° C. and hydrogen amount 650 mmol. The final polymer contained 3.6 w-% ethylene and had haze 38.7%. The other results are seen in Table 1.

### Comparative Example 1

This example was done in accordance with Example 1, except that the catalyst used was not VCH modified (contained no polyVCH), the hydrogen amount was 450 mmol and the polymerization temperature was 75° C. The final polymer contained 3.1 w-% ethylene and had haze 88.3%. The other results are seen in Table 1.

### Comparative Example 2

VCH modification in this example was done in the same way as in Example 1, but the VCH amount was decreased to VCH/catalyst weight ratio 0.8. VCH modification was done with Al/Ti and Al/Do molar ratio was 4.5. Polymerization was done as in Example 1, but with 550 mmol hydrogen. The final polymer contained 3.4 w-% ethylene and had haze 72.6% and the other results are seen in Table 1.

TABLE 1

| RANDOM PP | | Ex 1 | Ex 2 | Ex 3 | Ex 4 | Ex 5 | Comp ex 1 | Comp ex 2 |
|---|---|---|---|---|---|---|---|---|
| VCH modification | | | | | | | | |
| VCH/catalyst | weight ratio | 2 | 3.5 | 5 | 10 | 20 | 0 | 0.8 |
| Polymerisation | | | | | | | | |
| Catalyst amount (as dry) | mg | 7.6 | 11.2 | 14.4 | 16.2 | 15.6 | 10.5 | 9.9 |
| Hydrogen | mmol | 550 | 650 | 650 | 650 | 650 | 450 | 550 |
| Temperature | ° C. | 80 | 75 | 75 | 75 | 75 | 75 | 80 |
| Activity | kgPP/gcath | 76 | 60 | 45 | 40 | 41 | 64 | 66 |
| PolyVCH in polymer | ppm | 26 | 58 | 111 | 250 | 488 | 0 | 12 |
| Polymer | | | | | | | | |
| MFR₂ | g/10min | 13.1 | 8.4 | 9.2 | 8.4 | 7.7 | 8.2 | 11.6 |
| XS | w-% | 7.1 | 5.6 | 6.4 | 5.4 | 6.6 | 6.4 | 6.5 |
| Ethylene | w-% | 3.2 | 3.4 | 3.4 | 3.1 | 3.6 | 3.5 | 3.5 |
| Melting point | ° C. | 149 | 145.5 | 144 | 147 | 148.1 | 142.4 | 147.2 |
| Crystallisation point | ° C. | 118.5 | 115.9 | 115 | 117.9 | 118 | 107.6 | 116.3 |
| Haze 2 mm | % | 58 | 52.7 | 49.7 | 40.2 | 38.7 | 88.3 | 73 |
| Flexural modulus | MPa | 1040 | 1020 | 1010 | 1120 | 990 | 1010 | 1020 |

Additional examples were prepared using a two stage loop/gas phase reactor sequence as summarized in Table 2. This table also shows the properties of pellets obtained from these examples after compounding with the additives as given in Table 2.

TABLE 2

| | | Ex 6 | Ex 7 | Ex 8 | Ex 9 | Ex 10 | Ex 11 | Ex 12 |
|---|---|---|---|---|---|---|---|---|
| VCH/catalyst | weight ratio | 10 | 10 | 10 | 10 | 3 | 10 | 10 |
| Donor | type | D | D | D | D | D | D | D |
| AlTi ratio | mol/mol | 198 | Al/Ti 200 | Al/Ti 200 | Al/Ti 200 | Al/Ti 200 | Al/Ti 200 | Al/Ti 200 |
| Al/donor ratio | (mol/mol) | 10 | 10 | 10 | 11 | 10 | 10 | 10 |
| Loop | | | | | | | | |
| Temperature | ° C. | 80 | 70 | 85 | 70 | 75 | 80 | 80 |
| Split | % | 56 | 47 | 50 | 63 | 42 | 59 | 56 |
| MFR2 | (g/10 min) | 10.0 | 10.4 | 10.3 | 10.8 | 1.2 | 10.0 | 10.0 |
| ethylene | wt-% | 2.1 | 4.0 | 0.0 | 4.5 | 2.8 | 2.2 | 2.1 |
| XS | wt-% | 2.8 | 6.9 | 1.1 | 5.1 | 4.5 | 2.7 | 2.8 |
| GPR | | | | | | | | |
| Temperature | ° C. | — | 85 | 85 | 85 | 85 | 85 | 85 |
| Split | % | — | 53 | 50 | 37 | 58 | 41 | 44 |
| MFR2 | (g/10 min) | — | 10 | 9 | 9 | 1.4 | 9 | 10 |
| XS | wt-% | — | 4.0 | 3.2 | 3.7 | 7.6 | 5.9 | 5.9 |
| ethylene, calc | wt-% | — | 2.5 | 4.0 | 0.0 | 4.9 | 5.1 | 2.8 |
| pellets | | | | | | | | |
| MFR | g/10 min | 10.0 | 10.0 | 9.3 | 10.0 | 1.5 | 10.0 | 10.0 |
| Total ethylene | wt-% | 2.1 | 3.2 | 2.0 | 2.5 | 4.0 | 3.4 | 2.4 |
| Tm of PP | ° C. | 151.4 | 146.8 | 163.0 | 160.9 | 145.2 | 148.1 | 150.1 |
| crystallinity | % | 46.1 | 42.0 | 43.8 | 43.8 | 25.6 | 40.9 | 46.1 |
| Tcr of PP | ° C. | 120.3 | 119.6 | 130.1 | 129.2 | 114.0 | 120.7 | 121.2 |
| RDA, Zero | Pas | 3095 | 2674 | 2960 | 2731 | 16000 | 2880 | 2695 |
| viscosity | | | | | | | | |
| Shear thinning, | | 6.1 | 5.9 | 5.7 | 6.2 | 6.0 | 5.4 | 5.8 |
| SHI(0/50) | | | | | | | | |
| Polydispersity, PI | | 3.6 | 3.5 | 3.4 | 3.7 | 3.3 | 3.3 | 3.5 |
| Tens. stress at | MPa | 31.8 | 27.7 | 32.3 | 31 | 23.6 | 26.5 | 31.4 |
| yield | | | | | | | | |
| Tens. strain at | % | 11.3 | 12.2 | 11 | 11.7 | 12.7 | 12.3 | 11.2 |
| yield | | | | | | | | |
| Tensile modulus | MPa | 1250 | 1010 | 1270 | 1200 | 835 | 940 | 1240 |
| Charpy, notched, | kJ/m2 | 7.8 | 7.6 | 7.9 | 7.8 | 24.9 | 9.2 | 7.6 |
| RT | | | | | | | | |
| Haze 2 mm | % | 41 | 39 | 43 | 42 | 54 | 38 | 39 |
| PVCH | ppm | 567 | 286 | 266 | 347 | 85 | 234 | 245 |
| Irganox B 215 | | 1500 | 1500 | 1500 | 1500 | 1500 | 1500 | 1500 |
| CaSt | | 400 | 1000 | 1000 | 1000 | 1000 | 1000 | 1000 |
| GMS40 | | — | 1400 | 1400 | 1400 | 1400 | 1400 | 1400 |

(D: Dicyclopentyl dimethoxy silane)

The examples 6 to 12 were prepared in a continuous multistage process in pilot scale comprising a loop reactor and a fluidized bed gas phase reactor as follows:

The catalyst used was a highly active, stereospecific transesterified MgCl₂-supported Ziegler-Natta catalyst prepared analogously to Example 1. The catalysts are further characterized in Table 2. The catalyst of examples 6 to 9, 11 and 12 was modified with VCH as disclosed in Example 1, except that the weight ratio of VCH:catalyst was 10:1 and pentane was used for the modification medium. The catalyst of Example 10 was modified with VCH as disclosed in Example 1, except that the weight ratio of VCH:catalyst was 3:1. The catalyst was prepolymerized in a known manner in the presence of propylene and the co-catalyst in a separate prepolymerization step. Then propylene, ethylene and hydrogen were fed together with the prepolymerized catalyst into the loop reactor which operated as a bulk reactor at conditions given in Table 2 (production of loop fraction). Then the polymer slurry stream was fed from the loop reactor into the gas phase reactor and more propylene, ethylene and hydrogen were fed in the gas phase reactor (production of the gas phase reactor fraction in the presence of the loop-fraction). The polymerization conditions therein are given in Table 2, together with the properties of the pellets.

The Examples 6 to 12 again demonstrate the advantages of the present invention. Polypropylene compositions comprising at least one propylene copolymer component were obtained showing highly satisfactory haze values as well as good mechanical properties.

1. A polypropylene composition, comprising:
A) at least one propylene copolymer component, and
B) a polymeric nucleating agent, wherein
a mixture of A) and B) has an MFR₂ of 2 g/10 min or more as measured according to ISO 1133 (230° C., 2.16 kg load) and a haze, measured according to ASTMD 1003 in a form of an injection molded test piece having a thickness of 2 mm which satisfies the following relation:
Haze (%)<100.9·N^{(-0.1)}+3.88·MFR₂^{0.6}−19.1·Z^{0.5}−0.0232·MFR₂+2.41·Z+0.2 with
N=amount of polymeric nucleating agent in the propylene copolymer in ppm (weight)
MFR₂=MFR₂ of the mixture of A) and B) (ISO 1133, 230° C., 2.16 kg load) and
Z=comonomer content in the propylene copolymer component in wt-%, wherein Z is from 0.5 to 7 wt. %, wherein the polypropylene composition includes less than 1000 ppm of the polymeric nucleating agent.

2. A polypropylene composition, comprising:
A) at least one propylene copolymer component, and
B) a polymeric nucleating agent, wherein
a mixture of A) and B) has an MFR₂ of 2 g/10 min to 15 g/10 min measured according to ISO 1133 (230° C., 2.16 kg load) and a haze, measured according to ASTMD 1003 in a form of an injection molded test piece having a thickness of 2 mm, of below 55%, wherein the polypropylene composition includes less than 1000 ppm of the polymeric nucleating agent.

3. The polypropylene composition according to claim 1 wherein the copolymer is a random copolymer.

4. The polypropylene composition according to claim 1, wherein the MFR₂ is of 2 g/10 min to 50 g/10 min.

5. The polypropylene composition according to claim 1, wherein the polypropylene is unimodal with respect to a molecular weight distribution.

6. The polypropylene composition according to claim 5, wherein the polypropylene composition has a polydispersity index of 5 or less.

7. The polypropylene composition according to claim 5, wherein the propylene copolymer component has a shear thinning index, SHI_{0/50}, of less than 10.

8. The polypropylene composition according to claim 1, wherein the polypropylene composition fulfills at least one of the following conditions:
(a) containing no sorbitol derived nucleating agent;
(b) containing no metal salts of aromatic or aliphatic carboxylic acids and/or
(c) containing no phosphate salt derived nucleating agent.

9. The polypropylene composition according to claim 1, wherein the polymeric nucleating agent is at least one vinyl cyclohexane polymer.

10. The polypropylene composition according to claim 1, wherein the polypropylene composition is a reactor-made polypropylene composition.

11. The polypropylene composition according to claim 1, wherein the propylene copolymer comprises comonomers selected from ethylene, a-olefins and vinyl compounds.

12. The polypropylene composition according to claim 1, wherein the propylene copolymer comprises ethylene as a comonomer.

13. The polypropylene composition according to claim 1, wherein the polypropylene composition is multimodal with respect to a molecular weight distribution.

14. The polypropylene composition according to claim 13, wherein the composition is at least bimodal with respect to at least molecular weight distribution and comprises at least a propylene homo or copolymer component (a) and at least a propylene copolymer component (b) with differing MFR₂.

15. A polypropylene composition according to claim 1, obtained by preparing a propylene copolymer in the presence of a modified catalyst, wherein the modified catalyst is obtained by polymerizing a vinyl compound having the formula CH₂═CH—CHR₁R₂, wherein R₁ and R₂, together with the carbon atom they are attached to, form a substituted or unsubstituted saturated, unsaturated, aromatic ring or a fused ring system, wherein the ring or fused ring moiety contains four to 20 carbon atoms, at a weight ratio of the vinyl compound to polymerization catalyst of 2 or more, in the presence of said catalyst, until the concentration of unreacted vinyl compound is less than about 0.5 wt %.

16. The polypropylene composition according to claim 1, wherein the polypropylene composition comprises more than 15 ppm (weight) of the polymeric nucleating agent.

17. A polymerization catalyst, that is obtained by polymerizing a vinyl compound of the formula CH₂═CH—CHR₁R₂, wherein R₁ and R₂, together with the carbon atom they are attached to, form a substituted or unsubstituted saturated, unsaturated, aromatic ring or a fused ring system, wherein the ring or fused ring moiety contains four to 20 carbon atoms, at a weight ratio of the vinyl compound to polymerization catalyst amounting to 3 or more in the presence of said catalyst, until the concentration of unreacted vinyl compound is less than about 0.5 wt %.

18. A method for producing a polypropylene composition according to claim 1, comprising preparing a propylene copolymer using a polymerization catalyst obtained by polymerizing a vinyl compound of the formula CH₂═CH—CHR₁R₂, wherein R₁ and R₂, together with the carbon atom they are attached to, form a substituted or unsubstituted saturated, unsaturated, aromatic ring or a fused ring system, wherein the ring or fused ring moiety contains four to 20 carbon atoms, or independently represent H or a linear or branched C4-C30 alkane, C4-C20 cycloalkane, or C4-C20 aromatic ring, wherein at least one of R₁ and R₂ is not H, at a weight ratio of the vinyl compound to polymerization catalyst amounting to 3 or more in the presence of said catalyst, until the concentration of unreacted vinyl compound is less than about 0.5 wt %.

19. The method according to claim 18, wherein the polymerization of the vinyl compound is carried out in a medium which does not substantially dissolve the polymerized vinyl compound.

20. The method according to claim 18, wherein the vinyl compound is vinyl cyclohexane.
